(19) United States
(12) Patent Application Publication
(10) Pub. No.: US 2011/0310240 A1
(43) Pub. Date: Dec. 22, 2011

(54) DETECTION OF NON-PROTRUDING POTABLE WATER CONDUIT OR WATERMAIN SERVICES USING THERMAL IMAGING

(76) Inventors: Anthony Sudano, Laval (CA); Michael Davison, Brossard (CA); Benoît Côté, Otterburn Park (CA)

(21) Appl. No.: 12/639,328

(22) Filed: Dec. 16, 2009

Related U.S. Application Data
(60) Provisional application No. 61/138,480, filed on Dec. 17, 2008.

(51) Int. Cl. H04N 7/18

(52) U.S. Cl. 348/84; 348/E07.085

(57) ABSTRACT

A method and system of detecting a service entrance in a conduit having a rehabilitation liner, comprising generating heat using a heat source; introducing the heat into the lined conduit; allowing the lined conduit to cool; generating a thermal image of the lined conduit using an infrared camera system; detecting temperature differentiations in the lined conduit in order to detect a service entrance wherein the service entrance is a non-protruding service entrance, a partially-protruding service entrance or a service entrance in a saddle fixed to the conduit.

### CROSS-REFERENCE TO RELATED APPLICATION

This application claims the benefit under 35 U.S.C. § 119(e) of the earlier filing date of U.S. Provisional Application Serial Number 61/138,480 filed on Dec. 17, 2008, the entire disclosure of which is hereby incorporated by reference herein as if being set forth in its entirety.

### FIELD OF INVENTION

This application relates generally to the rehabilitation of underground small diameter potable water distribution conduits as well as large diameter watermains.

### BACKGROUND OF THE INVENTION

Trenchless methods are known for the rehabilitation of sewer and potable water conduits. Known methods include cured-in-place-piping (CIPP) and pulled-in-place-piping (PIPP), the major difference between the two applications being internal pressure. CIPP is achieved by producing a composite tube that is inserted or inverted into a host pipe. The composite is cured inside the host pipe to activate a resin system to produce a solid composite lining inside the pipe. An example of CIPP is disclosed in U.S. Pat. No. 5,384,086, this disclosure of which is incorporated by reference herein. Another method is disclosed in Canadian Patent #2 361 960 (US 2002/0058121) entitled “A Tubular Liner and Method of Rehabilitating of Conduits”, this disclosure of which is incorporated by reference herein.

As part of what is described in the aforementioned patent, once the damaged host pipe has been lined with a pulled and cured in place liner, the service entrances become obstructed by the continuous liner. A necessary step is the opening or unplugging of service entrances to allow water to once again have its original path to flow through. It is also described in the aforementioned patent that a camera and remote-controlled drilling device are used to perform this operation.

What are not always consistent are the orientation and the degree of penetration that the service connections are tapped into the potable water conduit or watermains. A non-exhaustive list of configurations commonly seen in the industry is as follows:
a) Service valve tapped into a potable water conduit or watermain whereby the service valve protrudes beyond the inner wall of the potable water conduit or watermain by a fair amount, herein known as protruding service.
b) Service valve tapped into a potable water conduit or watermain whereby the service valve barely protrudes beyond the inner wall of the potable water conduit or watermain, herein known as partially protruding service.
c) Service valve tapped into a potable water conduit or watermain whereby the service valve does not protrude beyond the inner wall of the potable water conduit or watermain, herein known as non-protruding service.
d) Service valve tapped into a service saddle which is clamped onto a potable water conduit or watermain whereby the service valve is not in contact with the potable water conduit or watermain. In this scenario, a hole exists, through which the water flows, is drilled or pierced in the potable water conduit or watermain generally in line with the service valve. This configuration is also herein known as a non-protruding service.

Once the liner is in place and cured, a closed-circuit television “CCTV” video camera which is normally introduced into the lined potable water conduit or watermain is used to locate the service entrance valves so that they can be unplugged. This is relatively simple and straight-forward for protruding and partially-protruding service entrances. On condition that the leading face of the service entrance is far enough beyond the inner wall of the potable water conduit or watermain, typically greater than about 0.25″, the bump or pimple is sufficiently visible via video camera to allow a remote operated commercially available robot and service opening device or drill to pierce through the liner and plug found in the service entrance which was installed prior to the lining operation, thus restoring the water flow path. However, locating the service entrance valves so that they can be unplugged is not obvious for non-protruding service entrances. In these cases, it is difficult and even impossible using methods commonly known in the art to discern a bump on the liner inner surface which is otherwise generated by a protruding or partially-protruding service entrance valve.

For non-protruding service entrances, one common but costly manner to open the service entrance is to excavate a pit from street level down to the potable water conduit or watermain, disconnect the service entrance fitting, pull back the copper pipe, and open the service entrance from the outside to remove the plug and pierce through the liner using a drill and drill bit. Then, the copper pipe and service entrance fitting must be re-assembled and the excavated hole must be back-filled. Finally, asphalt, grass or other surfacing material which was originally at the street level must be replaced.

For this reason, there is a need for a method and apparatus to accurately and simply detect and locate non-protruding service entrances in order that they may be unplugged to restore water flow through the service entrance valve.

### BRIEF DESCRIPTION OF THE DRAWINGS

FIG. 1 is a side view of an infrared camera in a potable water conduit or potable water conduit or watermain facing the service opening head or drill which is equipped with a convection heat source according to an embodiment of the invention.

FIG. 2 is and end view of the a potable water conduit or potable water conduit or watermain of FIG. 1 showing a non-protruding service entrance, and a convection heat source and service opening drill mounted on a commercially available robot.

FIG. 3 shows an end view of a potable water conduit or watermain with a protruding service entrance whereby the leading face of the service entrance is protruding beyond the inner wall of the potable water conduit or watermain by a substantial amount, typically 0.25″ to 0.5″ or more.

FIG. 4 shows an end view of a potable water conduit or watermain with a partially-protruding service entrance tapped into a potable water conduit or watermain whereby the leading face of the service entrance is partially protruding beyond the inner wall of the potable water conduit or watermain by less than 0.25″.

FIG. 5 shows an end view of a potable water conduit or watermain with a non-protruding service entrance tapped into a potable water conduit or watermain whereby the leading face of the service entrance is encapsulated within the wall of the potable water conduit or watermain.

FIG. 6 shows an end view of a potable water conduit or watermain with a service entrance which is fixed in a service saddle which in turn is clamped around a potable water conduit or watermain.

FIG. 7 is a side view showing an infrared camera in a potable water conduit or watermain facing the service opening and an external forced air convection heat source according to an alternate embodiment of the invention.

FIG. 8 is a drawing depicting the forced air heating device with its components including the housing, the fan, and the electrical resistance heating element.

### SUMMARY OF THE INVENTION

A method and system associated with the installation of tubular liners for rehabilitation of damaged underground potable water conduits and watermains. An embodiment of the invention is specifically tailored to be used in the process of lining small sized potable water distribution conduits as well as large diameter watermains and is capable of mounting on or being used in conjunction with commercially available service plugging and service opening equipment suited for such operations. Specifically, a method and system of detecting a service entrance in a conduit having a rehabilitation liner, comprises generating heat using a heat source; introducing the heat into the lined conduit; allowing the lined conduit to cool; generating a thermal image of the lined conduit using an infrared camera system; detecting temperature differentiations in the lined conduit in order to detect a service entrance wherein the service entrance is a non-protruding service entrance, a partially-protruding service entrance or a service entrance in a saddle fixed to the conduit.

### DETAILED DESCRIPTION OF THE INVENTION

It is understood that any reference and description of operations performed inside a potable water conduit or watermain is done on a given length of pipe via access pits at either extremity of the potable water conduit or watermain and that it has been previously emptied of water.

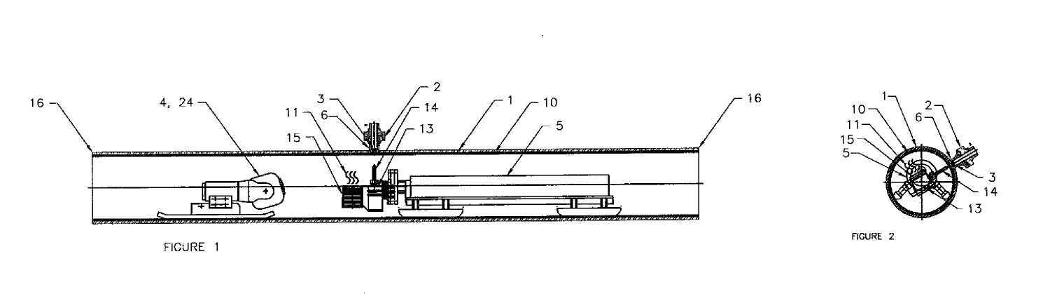

Referring to FIGS. 1 to 8, in one general respect, this application discloses a method and apparatus of detecting and accurately locating a non-protruding service entrance 6 so as it can be unplugged using an infrared camera 24 and a hot air device 15. The infrared camera 24 detects infrared energy (heat) and converts it into an electronic signal, which is then processed to produce a thermal image on a video monitor. Since the location of the application is in an underground potable water conduit or watermain 1, the conduit or watermain 1, the service entrance valves 2, the pulled and cured in place liner 10 and any other component which is in contact with or has been within the potable water conduit or watermain 1 is of similar or homogeneous temperature. Infrared camera 24 technology is based on discerning differentiating temperatures. Thus, since all components within the underground potable water conduit or watermain 1 are of similar temperatures, a method and apparatus must be introduced to vary the temperatures of the various components such that it becomes possible to discern a non-protruding service entrance 6 valve by the utilization an infrared camera 24. Different materials have respective thermal transfer characteristics or co-efficients. Thus, applying a temporary amount of heat to all components using a hot air device 15 and then allowing them to cool down naturally will result in each component being able to be visualized via the infra red camera 24 since they will cool down at different rates. The fact that the service entrance 2 was plugged prior to the lining operation with a polymeric plug 3 allows for a visual differentiation between the plug 3 and the service valve itself which is typically made of brass or other metallic material. This is visible via the infrared camera 24 even through the liner 10, which is typically composed of polymeric material or fabric and impregnated with curable resin.

A hot air device 15 (FIGS. 1 and 8) small enough and capable of directing the heat to the desired area is used. The hot air device 15 is made up of an electrical resistance heating element 20 and a fan 19 which forces air over the electrical resistance element and onward towards the area where is located the non-protruding 6 or partially protruding service 7. Both the fan 19 and the electrical resistance heating element 20 are housed in a casing 18 which house the components and allow for attaching it onto commercially available service opening apparatus.

In circumstances where the service entrance valve 2 is tapped in a service saddle 17 (FIG. 6) and thus not in contact with the potable water conduit or watermain 1, there still must exist a hole in the pipe through which the water must flow. In these instances, the hole in the pipe was also necessarily plugged prior to the lining process with a polymeric plug 3. The difference in materials between the potable water conduit or watermain 1 and the hole cause for the hole to be detected with the aid of an infra red camera 24.

As indicated previously, the infrared camera 24 on its own cannot discern objects if they are all at the same temperature. Heat must be introduced in the general area where the service entrance 2 exists. This heat can be applied by various techniques as follows:

1. Hot air generated electrically within the potable water conduit or watermain 1 and directed locally in the general area of the non-protruding service entrance 6.

2. Hot air generated electrically outside of the potable water conduit or watermain 1 and directed through the potable water conduit or watermain 1 from one end and exiting the opposite end.

3. Hot air generated via a vortex tube within the potable water conduit or watermain 1 using compressed air and directed locally in the general area of the non-protruding service entrance 6.

4. Hot air generated outside of the potable water conduit or watermain 1 via a vortex tube using compressed air and directed through the potable water conduit or watermain 1 from one end and exiting the opposite end.

5. Electrical resistance heating between the potable water conduit or watermain 1, if it is electrically conductive and the service line at the curb stop or at the main waterline entrance in the house, building, or other water consuming device.

6. Back flush of cold or hot water from the house, building, or user towards the potable water conduit or watermain 1. Note here that since the service entrance 2 is plugged, water will not actually flow but will allow for a temperature difference being generated at the service entrance valve 2 if it is tapped into the potable water conduit or watermain 1.

7. Other possible sources of heat generation can be conductive, radiant, hot liquid, or other plausible heat sources.

Various materials are involved in a typical application, be it cast iron, ductile cast iron, PVC plastic, asbestos-cement, or other potable water conduit or watermain 1, the liner 10, the service entrance 2 and the service entrance 2 plug 3. Each material has specific thermal characteristics or thermal co-efficient and thus absorbs and conducts heat at a different rate. Based on this property, by injecting heat locally and homogeneously to a non-visible service entrance 2 using a hot air device 15 and then allowing it to cool down will make it such that the various components will be at different temperatures. This allows the thermal imaging system to generate an image which is clear enough to discern the center of the service entrance 2 allowing for it to be drilled from within the potable water conduit or watermain 1 by common and known methods in the art.

FIG. 1 depicts an application whereby a non-protruding service entrance 6 is tapped into a potable water conduit or watermain 1. In this view, the service entrance 2 is already shown as being plugged and the potable water conduit or watermain 1 has already been rehabilitated with a liner 10. In this instance, since the service entrance 2 is non-protruding, there does not exist a bump or pimple 12 on the inner wall of the potable water conduit or watermain 1 which would otherwise be visible via a video camera 4.

In order for the center of the service entrance 2 to be discerned, the invention proposes that heat be applied in the general area of the service entrance 2 causing all components to increase in temperature from their similar starting temperature. After some time of applying heat, the various components attain a new, relatively homogeneous and higher temperature at which time the heat source is turned off.

The ground around the potable water conduit or watermain 1, which is at a similar temperature to the starting temperature of the potable water conduit or watermain 1, the service entrance 2, the plug 3, and the liner 10, will act as a heat sink and draw heat from the various components. Since the various components are of differing configurations and made of differing materials, each will cool down at a different rate. The thermal imaging or infrared camera 24 will detect the various temperatures and generate an image highlighting the center of the service entrance 2. At this point, the service entrance 2 can be opened via traditional and commercially available service opening robot 5 and drill 13.

In this instance, an electrically powered hot air device 15 is mounted on the head of the service opening drill 13 which is in turn mounted on a commercially available robot 5. The electrically powered hot air device includes a heat resistant housing 18, a fan 19, and an electrical resistance beating element 20. The described assembly along with an infrared camera 24 are brought to the general vicinity of the non-protruding 6 or partially-protruding service entrance 7 whose location was coarsely measured beforehand.

FIG. 2 shows a different view of a similar non-protruding service entrance 6 whereby the rehabilitating liner 10 masks the service entrance 2 from being visible via a video camera 4. In this view, the electrically powered hot air device 15 can be seen to be mounted at an angle to the service opening drill bit 14. The relative angle between the hot air device 15 and the service opening drill bit 14 is arbitrary and irrelevant to the success of this method since the hot air device 15 is rotated and moved around by the robot 5 while it is powered on to avoid creating any undue hotspots on the inner wall of the rehabilitating liner 10. In any case, the hot air device 15 is normally turned off while the service opening is ready to be performed. The positioning and angle of the hot air device 15 and the drill bit 14 is merely a space consideration to obtain the most compact assembly, something which is critical in small diameter potable water conduits or watermains 1.

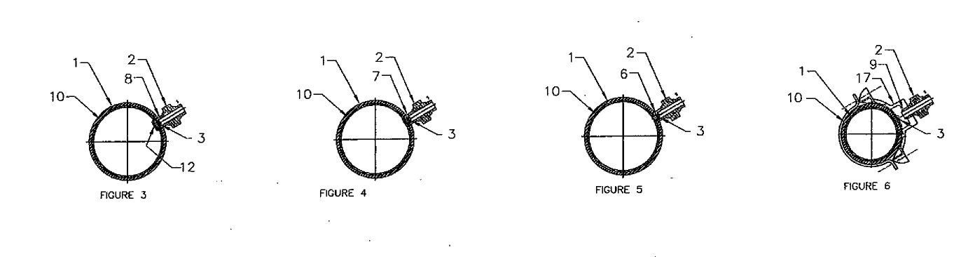

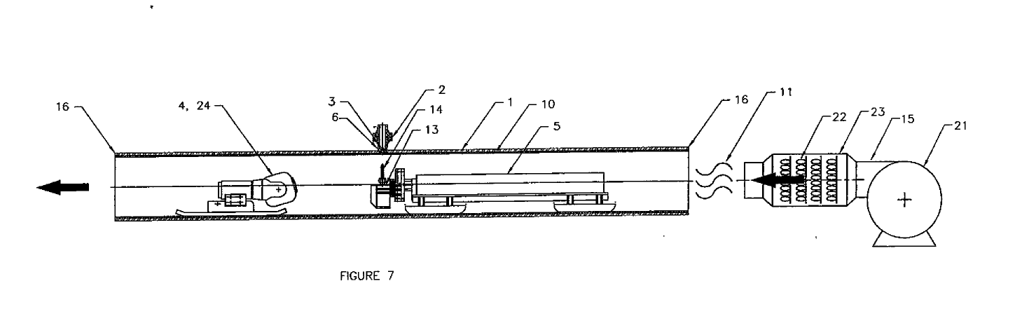

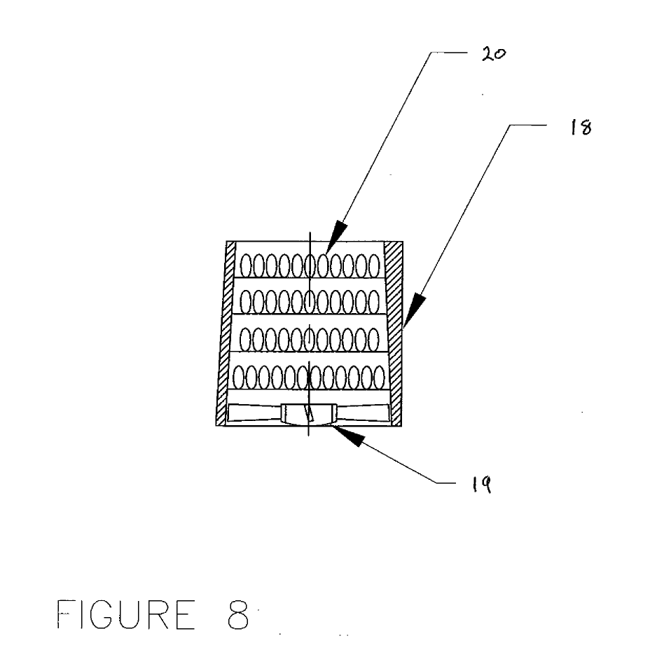

FIGS. 3 to 6 show some possible variations of service protrusions. FIG. 3 shows a protruding service entrance 8 whereby the leading face of the service entrance is protruding beyond the inner wall of the potable water conduit or watermain 1 by a substantial amount, typically 0.25″ to 0.5″ or more. FIG. 4 shows a partially-protruding service entrance 7 tapped into a potable water conduit or watermain 1 whereby the leading face of the service entrance is partially protruding beyond the inner wall of the potable water conduit or watermain by less than 0.25″. FIG. 5 shows a non-protruding service 6 entrance tapped into a potable water conduit or watermain 1 whereby the leading face of the service entrance is encapsulated within the wall of the potable water conduit or watermain. FIG. 6 shows service entrance 9 which is fixed in a service saddle 17 which in turn is clamped around a potable water conduit or watermain 1. Leak tightness between the saddle 17 and the potable water conduit or watermain 1 is assured via a gasket. In this instance, a through hole or flow hole is drilled in the potable water conduit or watermain 1 through which the water flows.

Other than heating the service entrance 2 area locally from within the potable water conduit or watermain 1, FIG. 7 illustrates the possibility of blowing hot air throughout the entire length of the potable water conduit or watermain 1 from one extremity 16 allowing the hot air to travel through the potable water conduit or watermain 1 and exiting the opposite end. The forced air convection 11 heat source is positioned outside of the potable water conduit or watermain 1. The hot air can be generated electrically using a fan-blower and an electrical resistance heating element, or by passing compressed air through a vortex generator creating hot air, or other techniques of generating hot air which can then be blown through the potable water conduit or watermain 1. In this instance, a fan blower 21 blows air over an electrical resistance duct heater 22 which is housed in a duct 23. The hot air flowing through the potable water conduit or watermain 1 will eventually heat the service entrance area and once the heat source is turned off, the components will cool down at variable rates, thus allowing the thermal imaging system to generate an image whereby the plugged service entrance can be discerned and opened using commercially available service opening apparatus.

Although preferred embodiments of the invention have been described in detail herein and illustrated in the accompanying drawings, it is to be understood that the invention is not limited to these embodiments and that various changes and modifications may be effected therein without departing from the scope or spirit of the invention.

If not otherwise stated herein, any and all patents, patent publications, articles and other printed publications discussed or mentioned herein are hereby incorporated by reference as if set forth in their entirety herein.

It should be appreciated that the apparatus and methods of the invention may be configured and conducted as appropriate for any context at hand. The embodiments described above are to be considered in all respects only as illustrative and not restrictive.

What is claimed is:

1. A method of detecting a service entrance in a conduit having a rehabilitation liner, the method comprising:
generating heat using a heat source;
introducing the heat into the lined conduit;
allowing the lined conduit to cool;
generating a thermal image of the lined conduit using an infrared camera system;
detecting temperature differentiations in the lined conduit in order to detect a service entrance.

2. The method of claim 1, wherein the service entrance is selected from the group consisting of non-protruding service entrance, partially-protruding service entrance and service entrance in a saddle fixed to the conduit.

3. The method of claim 1, wherein the heat source comprises electrically generated forced air convection.

4. The method of claim 3, wherein the electrically generated forced air convection comprises a fan which blows air over an electrical resistance heating element.

5. The method of claim 3, wherein the heat source is located outside of the lined conduit.

6. The method of claim 3, wherein the heat source is located inside of the lined conduit.

7. The method of claim 3, wherein the heat source comprises a vortex tube using compressed air.

7. The method of claim 3, wherein the heat source comprises an electrical resistance heating.

8. The method of claim 3, further comprising drilling through the liner to the detected service entrance.

9. A system of detecting a service entrance in a conduit having a rehabilitation liner, the system comprising:
a heat source for generating heat and introducing the heat into the lined conduit;
a thermal imaging system for generating a thermal image of the lined conduit and detecting temperature differentiations in the lined conduit in order to detect a service entrance.

10. The system of claim 9, wherein the service entrance is selected from the group consisting of non-protruding service entrance, partially-protruding service entrance and service entrance in a saddle fixed to the conduit.

11. The system of claim 9, wherein the heat source comprises electrically generated forced air convection.

12. The system of claim 11, wherein the electrically generated forced air convection comprises a fan which blows air over an electrical resistance heating element.

13. The system of claim 11, wherein the heat source is located outside of the lined conduit.

14. The system of claim 11, wherein the heat source is located inside of the lined conduit.

15. The system of claim 11, wherein the heat source comprises a vortex tube using compressed air.

16. The system of claim 11, wherein the heat source comprises an electrical resistance heating.
